(19) United States
(12) Patent Application Publication
(10) Pub. No.: US 2007/0008655 A1
(43) Pub. Date: Jan. 11, 2007

(54) FIXED-SHAFT HELICAL DRUM STRUCTURE WITH THE SHAFT SUPPORTED AT BOTH ENDS

(75) Inventor: Steven L. MAGNUSSON, Boulder, CO (US)

Correspondence Address: NIXON & VANDERHYE, PC, 901 NORTH GLEBE ROAD, 11TH FLOOR, ARLINGTON, VA, 22203, US

(73) Assignee: Exabyte Corporation, Boulder, CO (US)

(21) Appl. No.: 11/427,998

(22) Filed: Jun. 30, 2006

Related U.S. Application Data
(60) Provisional application No. 60/697,366, filed on Jul. 8, 2005.

(51) Int. Cl. G11B 5/52

(52) U.S. Cl. 360/271.6

(57) ABSTRACT

A drum assembly (20, 20(7)) for a helical scan recorder comprises a stationary first drum (22) and a shaft (24) having a shaft first end (26) centrally mounted to the first drum and a shaft second end (28). The drum assembly further comprises a rotatable second drum (32) which has at least one transducing element (34) mounted thereon. The shaft (24) extends axially through the second drum (32) and the shaft second end (28) protrudes axially above the second drum (32). The drum assembly also comprises a physical support member (40, 40(7)) connected to the first drum (22). The physical support member (40, 40(7)) is connected to the first drum (22) and also connected to stabilize the shaft second end (28) while allowing rotation of the second drum (32). The physical support member (40, 40(7)) is connected to the shaft second end (28) to reduce deflection of the shaft second end (28) when the drum assembly is exposed to external vibration or shock.

This application claims the benefit and priority of U.S. Provisional Patent Application No. 60/697,366, filed Jul. 8, 2006, the entire contents of which is incorporated by reference in its entirety.

### BACKGROUND

1. Technical Field

The present invention pertains to pertains to magnetic recording, and particularly to apparatus and method for recording stripes of information on a tape medium.

2. Related Art and Other Considerations

In helical tape drives, there are two basic types of drum constructions: (1) a first type with a central shaft that rotates with a portion of the drum where the heads are mounted (also known as a Rotating-Shaft type drum); and (2) a second type with a central shaft rigidly mounted to a stationary lower drum around which the drum portion where the heads are mounted rotates (a.k.a. Fixed-Shaft type). Additionally, within the Fixed-Shaft type drum family, there are both two piece designs and three piece designs. In the two piece designs, a lower drum is stationary and the heads are mounted to a rotating upper drum. The Exabyte VXA-2 tape drive is an example of a two piece Fixed-Shaft drum design, illustrated in FIG. 1. In the three piece designs, in which a lower drum is stationary, the heads are mounted to a rotating middle drum, and there is a stationary upper drum attached to the free-end of the shaft. The Exabyte VXA-3 tape drive is an example of a three piece Fixed-Shaft drum design, illustrated in FIG. 2.

In both of these existing, prior-art 2-piece and 3-piece fixed-shaft drum designs, the free-end of the shaft (i.e., the end of the shaft furthest away from the lower drum) has no direct physical connection, or support, to the lower drum. Consequently, when the drive is subjected to external vibration or shock conditions, the free-end of the shaft can be displaced easily relative to the lower drum due to the inertial loads placed on the shaft and the resulting flexing of the lower drum itself. This displacement of the free-end of the shaft causes the circular path followed by the heads to have a non-constant relationship to the lower drum, and consequently, causes the written track pattern on the tape to be non-uniform. FIG. 3 shows a schematic representation of how displacement of the free-end of the shaft relative to the lower drum causes the circular path of the head(s) to shift relative to the lower drum.

FIG. 4A shows a Ferrofluid image development of a standard Exabyte VXA-3 track pattern recorded with no external vibration present (using the prior-art, 3-piece fixed-shaft drum design as shown in FIG. 2). The track pattern of FIG. 4A is essentially uniform.

FIG. 4B shows a Ferrofluid image development of a standard Exabyte VXA-3 track pattern recorded during external vibration (again using the prior-art, 3-piece fixed-shaft drum as shown in FIG. 2). The track pattern of FIG. 4B is very non-uniform.

FIG. 5A shows a Ferrofluid image development of a standard Exabyte VXA-3 track pattern (with only one head writing) recorded with no external vibration (again using the prior-art, 3-piece fixed-shaft drum as shown in FIG. 2). The track spacing in FIG. 5A is essentially uniform.

FIG. 5B shows a Ferrofluid image development of a special Exabyte VXA-3 track pattern (with only one head writing) recorded during external vibration (again using the prior-art, 3-piece fixed-shaft drum as shown in FIG. 2. The track spacing of FIG. 5B is very non-uniform.

What is needed, therefore, and an object of the present invention, are techniques, apparatus, and method for overcoming undesirable effects in a recorded track pattern when a tape drive is subjected to external vibration and/or shock conditions.

### SUMMARY

A new physical structure is provided for either two piece or three piece fixed-shaft helical drums to minimize the effect that external vibration or shock conditions have on the recorded track pattern. A second physical support, which can take various forms, is added to act directly (or indirectly or quasi-directly) between the lower drum and the end of the shaft farthest away from lower drum.

In one of its aspects, the technology concerns a drum assembly for a helical scan recorder which comprises a stationary first drum and a shaft having a shaft first end centrally mounted to the first drum and a shaft second end. The shaft has a shaft axis which is co-axial with an axis of the first drum. The drum assembly further comprises a rotatable second drum which has at least one transducing element mounted thereon. The shaft extends axially through the second drum and the shaft second end protrudes axially above the second drum. The drum assembly also comprises a physical support member connected to the first drum. The physical support member is connected to the first drum and also connected to stabilize the shaft second end while allowing rotation of the second drum. The physical support member is connected to the shaft second end to reduce deflection of the shaft second end when the drum assembly is exposed to external vibration or shock.

In one example embodiment, the second drum is an uppermost drum of a two drum assembly. The shaft second end protrudes above the second drum and is engaged by the physical support member. In one example implementation, the physical support member has an aperture for engaging the shaft second end. The physical support member can be mechanically or adhesively attached to the first drum and to the shaft second end.

In another example embodiment the drum assembly comprises a stationary third drum positioned axially above the second drum. The third drum is rigidly mounted to the shaft second end. The physical support member is connected to the third drum, and is preferably connected to a peripheral surface of the first drum and to a peripheral surface of the third drum. The physical support member can be mechanically or adhesively attached to the third drum.

In a two piece drum design such as the first example embodiments, this new or secondary support (e.g., physical support member) can comprise a bridge, bracket, or brace which is connected both to the lower drum and to the end of the fixed shaft which protrudes above the upper drum. In a three piece design such as the second embodiment, this new or secondary support comprises a bridge, bracket, or brace which connects the (stationary) lower drum and the (stationary) upper drum, and thereby provides further vibration-dampening support for the end of the shaft already connected to the stationary upper drum.

Adding this additional support reduces the deflection of the end of the shaft farthest away from the lower drum when exposed to external vibration or shock conditions, and consequently, keeps the circular path followed by each head in a more consistent position relative to the lower drum, which, in turn, produces a more consistent track pattern on the tape.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a cross-sectioned side view of an example two piece Fixed-Shaft drum for a helical scan tape drive.

FIG. 2 is a cross-sectioned side view of an example three piece Fixed-Shaft drum for a helical scan tape drive.

FIG. 3 is a diagrammatic view illustrating how displacement of a free-end of a shaft relative to a lower drum causes a circular path of head(s) to shift relative to the lower drum.

FIG. 4A is a Ferrofluid image development of a track pattern recorded by a first tape drive with no external vibration present.

FIG. 4B is a Ferrofluid image development of a track pattern recorded by the first tape drive during external vibration.

FIG. 5A is a Ferrofluid image development of a track pattern recorded by a second tape drive with no external vibration present.

FIG. 5B is a Ferrofluid image development of a track pattern recorded by the second tape drive during external vibration.

FIG. 6 is a cross-sectioned side view of an example embodiment of 2-piece fixed-shaft drum assembly of a tape drive, the drum assembly having a support piece added to act directly between the (stationary) lower drum and the (stationary) previously-free-end of the fixed shaft.

FIG. 7A is a perspective view of an example embodiment of 3-piece fixed-shaft drum assembly of a tape drive, the drum assembly having a support piece added to act directly between the (stationary) lower drum and the (stationary) upper drum.

FIG. 7B is a cross-sectioned side view of the example embodiment drum assembly of FIG. 7A.

FIG. 8 is an isometric front view of an example embodiment of a physical support member for use with the example embodiment of FIG. 7A and FIG. 7B.

FIG. 9 is a Ferrofluid image development of a special Exabyte VXA-3 track pattern (with only one head writing) recorded using a prototype of the embodiment shown in FIG. 7 during same external vibration condition as FIG. 5B.

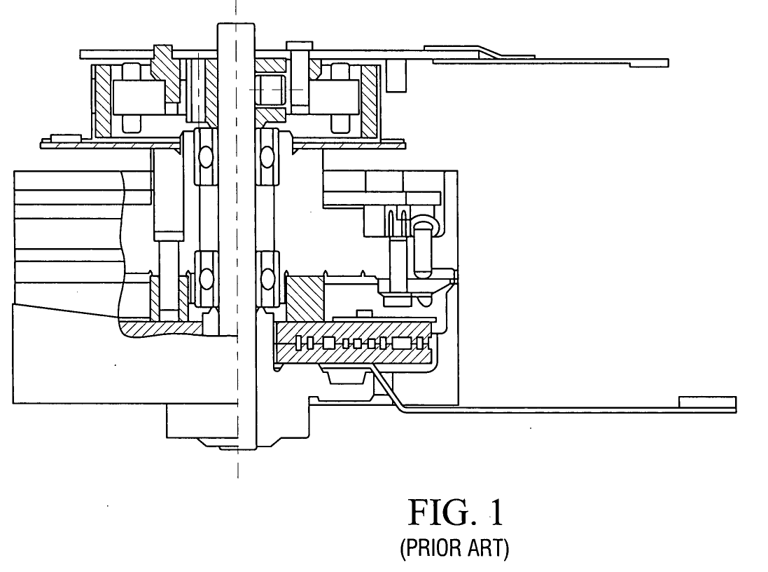

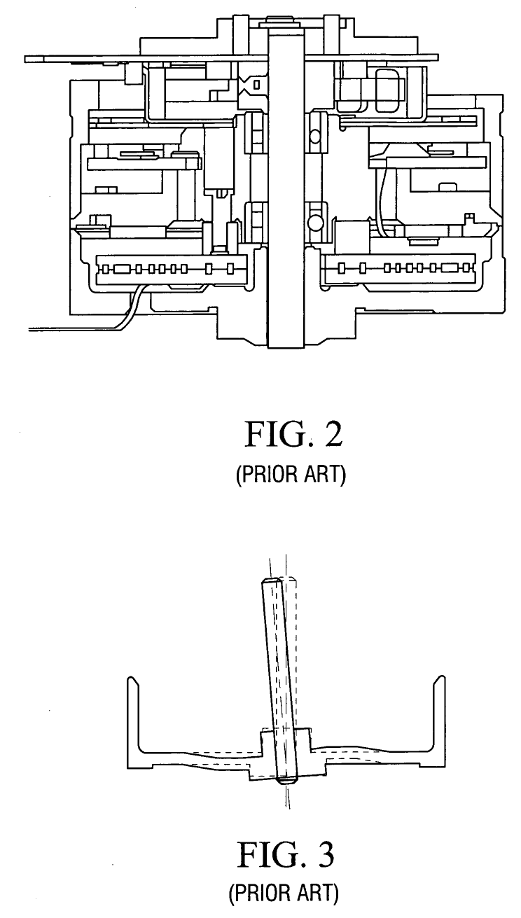

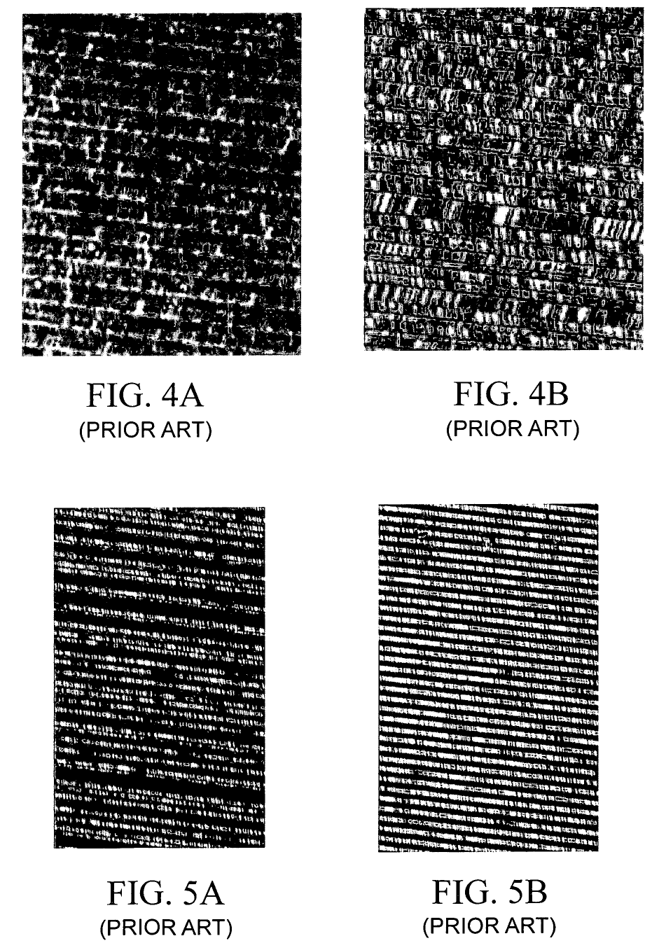

### DETAILED DESCRIPTION OF THE DRAWINGS

In the following description, for purposes of explanation and non-limitation, specific details are set forth, such as particular nodes, functional entities, techniques, protocols, standards, etc. in order to provide an understanding of the described technology.

A new physical structure is provided for either two piece or three piece fixed-shaft helical drums to minimize the effect that external vibration or shock conditions have on the recorded track pattern. A second physical support (also known as a physical support member), which can take various forms, is added to act directly (or indirectly or quasi-directly) between the lower drum and the end of the shaft farthest away from lower drum.

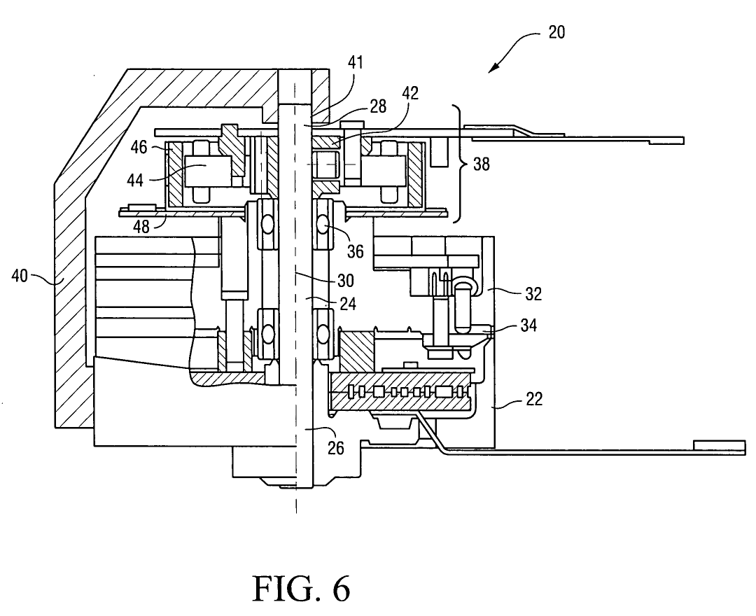

FIG. 6 shows a first example embodiment of a drum assembly 20 for a helical scan recorder. The drum assembly 20 comprises plural drums (including a first drum 22) and a shaft 24. The first drum 22 is stationary, and thus hereinafter referred to as the stationary first drum 22. The shaft 24 has a shaft first end 26 which is centrally mounted to stationary first drum 22 and a shaft second end 28. The shaft has a shaft axis 30 which is co-axial with an axis of stationary first drum 22. The drum assembly 20 further comprises a rotatable second drum 32 which has at least one transducing element 34 mounted thereon. The shaft 24 extends axially through rotatable second drum 32, and in fact shaft second end 28 protrudes axially above rotatable second drum 32. The rotatable second drum 32 rotates about shaft 24 by virtue, e.g., of bearings 36 provided concentrically around shaft 24 and between shaft 24 and rotatable second drum 32.

FIG. 6 also shows that a drum motor assembly 38 is mounted above rotatable second drum 32. The drum motor assembly 38 drives the rotating drum, e.g., drives the rotatable second drum 32 of the FIG. 6 embodiment. The drum motor assembly 38 is preferably a DC-brushless drum motor. The drum motor assembly 38 is mounted concentrically about shaft 24.

The drum assembly 20 also comprises a physical support member 40 which is connected to stationary first drum 22 and also connected to stabilize shaft second end 28 while allowing rotation of rotatable second drum 32. The physical support member 40 is connected to shaft second end 28 in a manner and for the purpose of reducing deflection of shaft second end 28 when the drum assembly is exposed to external vibration or shock.

In the first example embodiment of FIG. 6, rotatable second drum 32 is an uppermost drum of a two drum assembly 20. The shaft second end 28 protrudes above rotatable second drum 32. Above drum motor assembly 38 the shaft second end 28 is engaged by physical support member 40. In one example implementation shown in FIG. 6, physical support member 40 has an aperture 41 for engaging shaft second end 28. In other words, shaft second end 28 fits coaxially through the aperture 41 of physical support member 40. The physical support member 40 can be mechanically or adhesively attached to stationary first drum 22 and to shaft second end 28

As shown in FIG. 6, physical support member 40 is fixedly attached both to stationary first drum 22 and shaft second end 28, and yet extends around rotatable second drum 32 so that rotatable second drum 32 (including transducing element 34 carried radially thereon) has sufficient radial clearance to rotate.

In the FIG. 6 embodiment, a collar 42 is attached by a setscrew to the shaft second end 28 for holding the rotatable second drum 32 (with bearings) onto shaft 24 and the lower (stationary) first drum 22. Extending above in plate-like fashion and also around collar 42 is a (non-rotating) stator section 44 of drum motor assembly 38. The stator section 44 is attached to collar 42. A rotor section 46 of drum motor assembly 38 has a flat bottom plate 48 which is attached to a top of rotatable second drum 32 (e.g., by fasteners). The rotor section 46 imparts rotational motion to rotatable second drum 32.

Thus, FIG. 6 shows an example first embodiment drum assembly 20 where the new support piece 40 is added to a two piece fixed drum design. The new support piece 40 acts directly between the (stationary) lower drum 22 and the (stationary) previously-free-end 28 of the fixed shaft 24. As such, in the example implementation of FIG. 6 the support piece 40 is connected both to the lower drum 22 and to the end 28 of the fixed shaft 24 which protrudes above the upper drum 32. The support piece 40 can take the form of a bracket, brace, or bridge and can be mechanically or adhesively attached to the protruding end 28 of the shaft 24 (e.g., the end of the shaft which otherwise would be free).

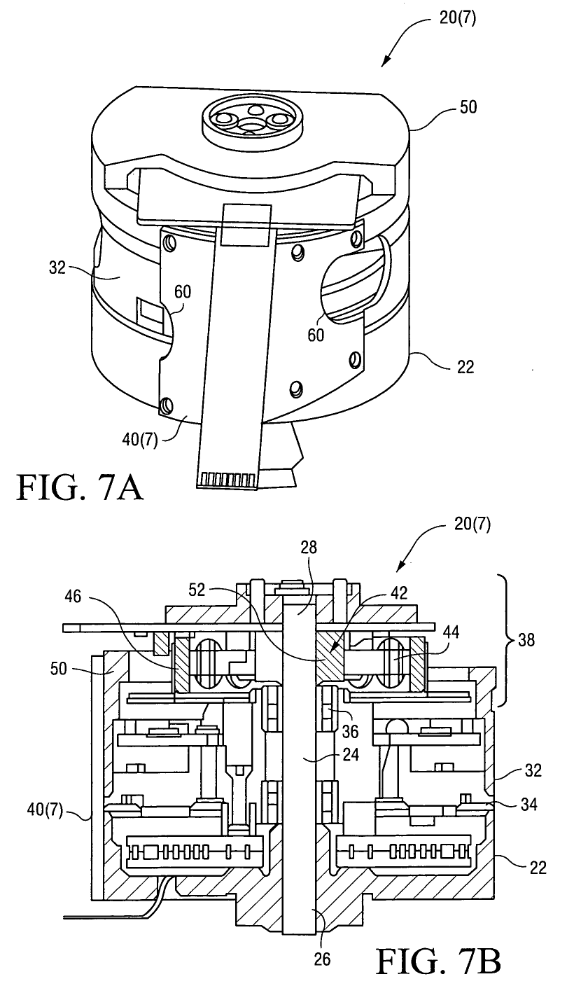

FIG. 7A and FIG. 7B illustrate an example drum assembly 20(7) comprising three drums. Members of the drum assembly 20(7) of FIG. 7 which are like or similar to members of drum assembly 20 of FIG. 6 are similarly numbered, including (but not limited to) stationary first drum 22; shaft 24 with its shaft first end 26 and shaft second end 28; rotatable second drum 32; and drum motor assembly 38. The drum assembly 20(7) of the second example embodiment further comprises a stationary third drum 50 positioned axially above rotatable second drum 32. The stationary third drum 50 is rigidly mounted to collar 42 and thus to shaft second end 28. The physical support member 40(7) is connected to stationary third drum 50, and is preferably connected to a peripheral surface of stationary first drum 22 and to a peripheral surface of stationary third drum 50. The physical support member 40(7) can be mechanically or adhesively attached to stationary third drum 50.

FIG. 7A and FIG. 7B thus show another embodiment of drum assembly 20(7) wherein the new support piece 40(7) is added to a three piece fixed-shaft drum assembly to act directly between the (stationary) lower drum 22 and the (stationary) upper drum 50. Since the upper drum 50 is already directly connected to the previously-free-end 28 of the fixed shaft 24 (via a bearing retainer 52), with the new support piece 40(7) in-place, the previously-free-end 28 of the shaft 24 is now supported relative to the lower drum 22.

In the three piece (e.g., three drum) design such as the second embodiment of FIG. 7A and FIG. 7B, this new or secondary support 40(7) can comprises a bridge, bracket, or brace which connects the (stationary) lower drum 22 and the (stationary) upper drum 50, and thereby provides further vibration-dampening support for the end 28 of the shaft already connected to the stationary upper drum 50. Adding this additional support 40(7) reduces the deflection of the end 28 of the shaft 24 farthest away from the lower drum 22 when exposed to external vibration or shock conditions, and consequently, keeps the circular path followed by each head in a more consistent position relative to the lower drum, which, in turn, produces a more consistent track pattern on the tape.

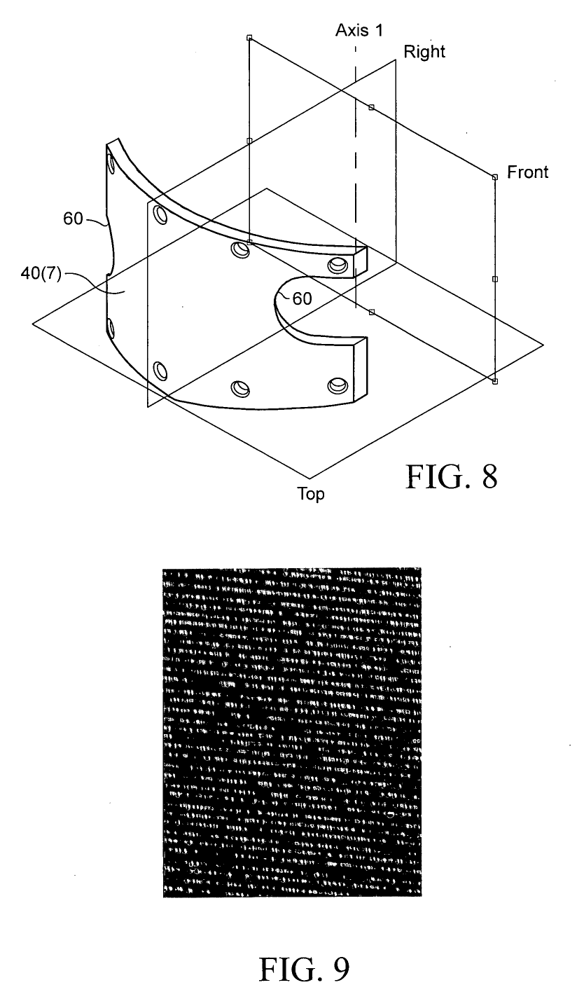

FIG. 8 shows an example embodiment of a physical support member suitable for use as the physical support member 40(7) of FIG. 7. As shown in FIG. 8, physical support member 40(7) has a hollow semi-cylindrical or curved shape for extending around a peripheral portion of the drums comprising the drum assembly. The physical support member 40(7) has fastener holes for facilitating fastening to stationary first drum 22 and to the third drum 60. The physical support member 40(7) has arcuate shaped top and bottom edges, as well as side edges that are essentially parallel to the shaft axis 30.

On the opposing side edges the physical support member 40 has removed portions or cutouts 60A and 60B which are configured with a cutout to permit access to a portion of the drum assembly. The cutout 60A ensures that a finger opening in the upper drum is not obscured; the cutout 60B provides a clearance around a rectangular opening in the upper drum for an unillustrated cleaning wheel. During final setting of the head heights, it is useful/necessary that a technician temporarily be able to prevent the rotating drum section from rotating. The width of the rotating middle drum section at its outermost diameter is very small, for which reason it best to not touch it at all so that it remains clean and undamaged. Consequently, two finger openings visible in FIG. 7A are cut thru the upper drum in the area where the tape does not contact the upper drum so that, by using a thumb and forefinger (one in each opening), the technician can hold the rotating drum section in areas that do not contact the tape.

FIG. 9 is a Ferrofluid image development of a special Exabyte VXA-3 track pattern (with only one head writing) recorded using a prototype of the embodiment shown in FIG. 7A and FIG. 7B during same external vibration condition as FIG. 5B. The resulting recorded track pattern of FIG. 9 is much improved compared to FIG. 5B.

It will be appreciated that, in the example embodiments described herein, the drum assembly is mounted on a drive deck or the like in proper position along a tape path, e.g., between a tape supply reel and a tape takeup reel. The rotation of rotatable second drum 32 is imparted by drum motor assembly 38. The drum assembly further comprises electronics for supplying a recording signal to the transducing element(s) 34 on the rotatable second drum 32, as well as electronics for processing (e.g., reproducing) a signal read or acquired from the tape. These general features of a helical scan drive are understood from one or more of the following United States Patents, all of which are incorporated herein by reference in their entirety: U.S. Pat. No. 6,985,323; U.S. Pat. No. 6,809,897; U.S. Pat. No. 6,870,698; U.S. Pat. No. 6,778,361; U.S. Pat. No. 6,757,123; U.S. Pat. No. 6,697,209; U.S. Pat. No. 6,603,618; U.S. Pat. No. 6,459,540; U.S. Pat. No. 6,411,805; U.S. Pat. No. 6,189,824; U.S. Pat. No. 5,978,165; U.S. Pat. No. 5,731,921; U.S. Pat. No. 5,726,826; U.S. Pat. No. 5,065,261; U.S. Pat. No. 5,068,757; U.S. Pat. No. 5,141,412; U.S. Pat. No. 5,191,491; U.S. Pat. No. 5,535,068; U.S. Pat. No. 5,602,694; U.S. Pat. No. 5,680,269; U.S. Pat. No. 5,689,382; U.S. Pat. No. 5,734,518; U.S. Pat. No. 5,953,177; U.S. Pat. No. 5,973,875; U.S. Pat. No. 5,978,165; and U.S. Pat. No. 6,144,518.

The invention is not confined to the particular shaft support structures herein described, but encompasses other structures and/or mechanisms for providing vibration-dampening support or contact to a distal end of a drum shaft, e.g., an end of a drum shaft which conventionally is free or protrudes above an upper drum.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. It is to be understood that the invention is not to be limited to the disclosed embodiment, but on the contrary, is intended to cover various modifications and equivalent arrangements.

What is claimed is:

1. A drum assembly for a helical scan recorder comprising:
a stationary first drum;
a shaft having a shaft first end centrally mounted to the first drum and a shaft second end, the shaft having a shaft axis which is co-axial with an axis of the first drum;
a rotatable second drum, the second drum having at least one transducing element mounted thereon;
wherein the shaft extends axially through the second drum and the shaft second end protrudes axially above the second drum;
a physical support member connected to the first drum;
a physical support member connected to the first drum and connected to stabilize the shaft second end while allowing rotation of the second drum.

2. The apparatus of claim 1, wherein the physical support member is connected to the shaft second end to reduce deflection of the shaft second end when the drum assembly is exposed to external vibration or shock.

3. The apparatus of claim 1, further comprising a stationary third drum positioned axially above the second drum, the third drum being rigidly mounted to the shaft second end, and wherein the physical support member is connected to the third drum.

4. The apparatus of claim 3, wherein the physical support member is connected to a peripheral surface of the first drum and to a peripheral surface of the third drum.

5. The apparatus of claim 3, wherein the physical support member is mechanically or adhesively attached to the shaft second end.

6. The apparatus of claim 1, wherein the physical support member has an aperture for engaging the shaft second end.

7. The apparatus of claim 1, wherein the physical support member is mechanically or adhesively attached to the shaft second end.

8. The apparatus of claim 1, wherein the physical support member has a hollow semi-cylindrical or curved shape for extending around a peripheral portion of the stationary first drum and the rotatable second drum, wherein the physical support member has side edges that are configured with a cutout to permit access to a portion of the drum assembly.
